(19) United States
(12) Patent Application Publication
(10) Pub. No.: US 2012/0274639 A1
(43) Pub. Date: Nov. 1, 2012

(54) Method for Generating images of three-dimensional data

(76) Inventors: Simon Boy, Stuttgart (DE); Dieter Morgenroth, Grafenau-Doeffingen (DE); Stefan Broecker, Stuttgart (DE)

(21) Appl. No.: 13/064,975

(22) Filed: Apr. 29, 2011

(51) Int. Cl. G06T 15/50

(52) U.S. Cl. 345/426

(57) ABSTRACT

At least one example embodiment discloses a process to generate images of software generated (CAD) 3D data of a product. The example embodiment allows, with computer performance, to carry out image edits of a sketch at the computer. When the sketch is acceptable, the image with a simplified representation of the product to be shown is sent to a render house. The render house integrates the image to a full-standard image representing the product to be shown as a 3D-object with a certain color, with certain surface characteristics, such as high-gloss or matt, etc.

### BACKGROUND

Images, e. g. for advertising means, may be in printed form or on the internet, may be made outside outdoors of a photo studio. Illumination and a background of the image may be digitally generated in a process of digital image generation. The result is a so-called “computer generated image (CGI)”. The generation of such a CGI with the assistance of efficient computers, is cost-saving and flexible for large and top-quality products, as e. g. cars or lorries, thar the generation of a photo having a real background.

The process for generating such computer generated images according to the prior art is described in detail in the following. Table 1 briefly shows the different process steps of the CGI-Process and what executes the step (render house or client).

TABLE 1

| Role | Process step |
|---|---|
| Render house | Data preparation: |
| | preparation of |
| | visualization data |
| | preparation of backgrounds |
| | preparation of |
| | configuration logic |
| Render house | Setup perspective and lighting |
| Client | Approval of data |
| Render house | 3D rendering |
| Render house | Retouching, creation and |
| | delivery of final images |
| Client | Approval of final images |

From table 1, except the approval of data and the final images, all steps are executed by the render house. This makes the CGI-Process expensive and inflexible.

The fact that the CGI-Process is inflexible constitutes, besides the high costs, a main impediment to the further spreading of the CGI-Process of product images. A further impediment to the implementation of the CGI-Process is the creative work of the image creator, as e. g., of a graphic designer in an advertising agency, continuously is interrupted, as the sketches of the image creator are completed to a finished image in the Render house. This finished image is then submitted to the image creator for examination and approval. Amendments are not carried out by the image creator until that time. Should the image creator not be satisfied with the result of the CGI, then the image creator once again initializes the process of image creation, has this further sketch of the image completed in the Render house and subsequently assessed. Thus, the creative process of the image creator is continuously interrupted, which first of all impedes the creativity of the image creator and secondly increases the time duration to the generation of a complete image corresponding to the ideas of the image creator. Of course, this is accompanied by considerable costs for the generation of a CGI.

### SUMMARY

Some abbreviations and technical terms being relevant in connection with example embodiments are explained.

At least one example embodiment of the invention is a new process of generating image of software generated (CAD) 3D data of a product. This new process may be called “Picture Shooter Process” or “Picture Shooter Application”. To describe the Picture Shooter Process it is compared with a manual process of data visualization.

The following is a glossary of terms and abbreviations relevant to example embodiments.

| Term | Definition |
|---|---|
| Render house | Company that offers data preparation and |
| | three dimensional (3D) rendering/ |
| | calculating services. |
| CAD-Data | 3D Data generated from Computer Aided Design |
| | (CAD). |
| CGI | Computer Generated Images. Images that were |
| | calculated (rendered) from 3D data. |
| CG | Computer Generated. |
| HDRI | High Dynamic Range Image. Images with a |
| | greater dynamic range of luminance between |
| | the lightest and darkest areas of an image |
| | than current standard digital imaging |
| | techniques or photographic methods. |
| Rendering | Generating an image from a model by means of |
| | computer programs from virtual 3D models |
| Image based | A 3D rendering technique which involves |
| Lighting | plotting an image onto a dome or sphere that |
| | contains a primary subject. The lighting |
| | characteristics of the surrounding surface |
| | are then taken into account when rendering a |
| | scene, using modeling techniques of global |
| | illumination. This is in contrast to light |
| | sources such as a computer-simulated sun or |
| | light bulb, which are more localized. For |
| | more information see: |
| | http://en.wikipedia.org/wiki/Image- |
| | based_lighting (the entire contents of which |
| | are hereby incorporated by reference) |
| SIBL | Smart Image Based Lighting. Open standard to |
| | organize all images used for Image Based |
| | Lighting. |
| | For more information see: |
| | http://www.hdrlabs.com/sibl/index.html (the |
| | entire contents of which are hereby |
| | incorporated by reference) |
| Renderqueue | Waiting line for render jobs |
| Renderslave | A computer reserved for executing renderjobs. |
| Renderjob | Task of generating/rendering an image. |
| Renderfarm | System to manage a renderqueue, renderjobs |
| | and renderslaves. |
| UI | User-Interface. The user interface is a space |
| | where interaction between humans and machines |
| | occurs. |
| Shader | A shader is a set of software instructions |
| | that is used to calculate rendering effects. |
| | Simply said, a shader defines the appearance |
| | of an object using attributes like color, |
| | reflection, transparency. |

Example embodiments provide a method of generating CGIs, which first of all supports the creative work of the image creator, can be implemented faster, and furthermore, reduces costs as to the computer-performance in the Render house, so that the occurring costs are reduced.

According to at least one example embodiment of the invention this task is solved by the Picture Shooter Process. A feature of this method is that the image creator has more influence on the image creation and does not depend on every intermediate-step during the creation of a CGI the Render house carries out, until the termination of which the image creator does not have influence on the image creation.

With the method according to at least one example embodiment the invention, it is provided that due to the configuration of the CGI-Process, the actual image design including the positioning of the product within the landscape, the adjustment of illumination parameters, etc., takes place at the PC of the client/image creator. The image creator, without making use of the Render house, may differently position the product by moving it in the background, amending the illumination, etc. The product to be represented, in this creative phase of the CGI-Process, is not shown in full resolution and with all colors, but rather as a CAD-lattice structure on the screen of the client/image creator. Thus, it is possible, with the computer performance of a client-PC, to carry out all image edits of the sketch at the PC with the CPU of the client-PC. When the image creator deems this sketch as acceptable, then this image with the simplified representation of the product to be shown is sent to the Render house to be integrated to a full-standard image representing the product to be shown as a 3D-object with a certain color, with certain surface characteristics, such as high-gloss or matt, etc. For this purpose, only the computer performance of the Render house may be used. As this, however, is used at the end of the creative process, the computer performance demanded by the Render house decreases dramatically, so that the costs for using the Render house are reduced. Furthermore, the image creator can terminate the creative process of the image generation without interruptions and thus more efficiently and in a shorter time. Moreover, costs are saved this way. Otherwise the Picture-Shooter-Process according to the invention is also more intuitive, as it rather obliges the proceeding of an image creator during the generation of a CGI.

### BRIEF DESCRIPTION OF THE DRAWINGS

Additional features, options for use and advantages of the invention can be deduced from the following description of example embodiments of the invention which are shown in the Figures. All described or illustrated features by themselves or in any optional combination in this case represent the subject matter of the invention, regardless of how they are combined in the patent claims or of the references back and regardless of how they are formulated and/ore described in the description or illustrated in the drawings.

FIG. 1 illustrates a Picture Shooter Process according to an example embodiment;

FIG. 2 illustrates a method of data preparation according to an example embodiment;

FIG. 3 illustrates a method of importing data according to an example embodiment; and

FIG. 4 shows an automatically rendered number plate texture.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

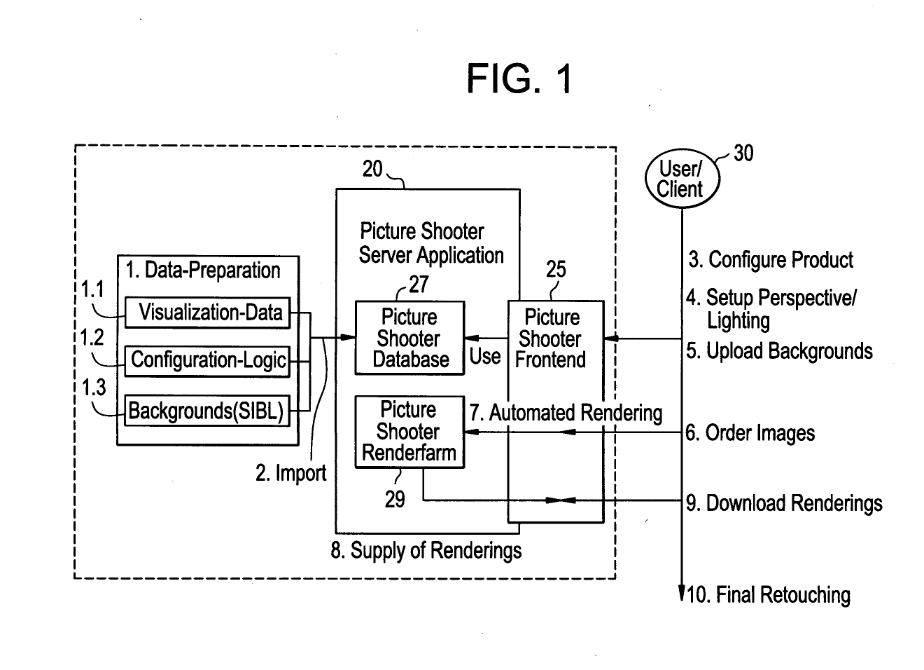

In the following the Picture-Shooter-Process according to at least one example embodiment of the invention is shown in detail by FIGS. 1 to 3.

FIG. 1 illustrates a Picture Shooter Process according to an example embodiment.

From FIG. 1 it can be seen that the Picture Shooter Process may include ten (10) steps. Some of the steps are compulsory and some are optional. These steps are described briefly in table 2 and in more detail below.

As shown in FIG. 1, a render house 10 is configured to perform data preparation at step 1. The data preparation includes preparation of visualization data (1.1), preparation of backgrounds (1.3) and preparation of configuration logic (1.2).

The render house 10 hosts a picture shooter server application 20. As shown a user/client 30 has access to the picture shooter server application 20. At step 2, the prepared data is imported to the picture shooter server application 20.

The user/client 30 configures product data at step 3, performs perspective/lighting setup at step 4, uploads backgrounds at step 5 and orders 3D images at step 6.

The picture shooter server application 20 is configured to receive to configured product data, perspective/lighting data, backgrounds and the ordered 3D images at a picture shooter frontend 25. The picture shooter frontend 25 uses the configured product data, perspective/lighting data, backgrounds in a picture shooter database.

At step 7, the picture shooter server application renders the ordered 3D images in a picture shooter renderfarm 29 of the picture shooter server application 20. The picture shooter renderfarm 29 includes render servers. The render servers include at least one picture shooter render engine. The picture shooter render engine calculates/renders an image based on 3D visualization data. The at least one picture shooter render engine runs on the render servers. At step 8, the picture shooter server application 20 supplies the renderings to the picture shooter frontend 25.

At step 9, the user/client 30 downloads the renderings from the picture shooter frontend 25. At step 10, the user/client 30 retouches the renderings.

Table 2 illustrates a summary of the Picture Shooter Process.

TABLE 2

| Role | Process step |
|---|---|
| Render house 10 | Data preparation (step 1): |
| | preparation of |
| | visualization data (1.1) |
| | preparation of backgrounds |
| | (1.3) |
| | preparation of |
| | configuration logic (1.2) |
| Render house 10 | hosting of a Picture |
| | Shooter application 20 |
| | client has access to the |
| | Picture Shooter Application 20 |
| | via internet |
| | (step 2) |
| Client/Picture Shooter user | Configure Product (step 3) |
| 30 | |
| Client/Picture Shooter user | Setup perspective and lighting |
| 30 | (step 4) |
| Client/Picture Shooter user | Upload of background images |
| 30 | (step 5) |
| Client/Picture Shooter user | Ordering of images (step 6) |
| 30 | |
| Picture Shooter Server | Automated rendering of 3D |
| Application 20 | images (step 7) |
| | Supply of images (step 8) |

Compared to conventional CGI workflow, the render house 10 is only involved in the data preparation and upload of the data. The picture shooter application 20 automates the process from the uploaded dataset to the 3D rendering in steps 5, 6 and 7.

The supply of the renderings, at step 8, and the download of the renderings, at step 9, organizes the data transfer between the render house 10 and the user/client 30. The retouching at step 10 can then be done by the user/client 30 or any 3rd party service.

Consequently, the client 30 has easy access to complex 3D data via the internet, which connects the user/client 30 to the picture shooter server application 20. No special knowledge or special resources are required (disk space, High-performance computer, 3D rendering software) at the user/client 30.

Creative decisions are not managed with approval processes but are made working with the picture shooter application 20.

Subsequently each step 1 to 10 is described in detail.

### Step 1.1: Data Preparation of Visualization Data

The render house 10 is configured to receive input for data preparation. The input for data preparation is CAD data of the geometry of the product and information about the appearance of the surfaces. The input for data-preparation may be reference photos of similar surfaces or scans of similar surfaces. The visualization data is 3D data.

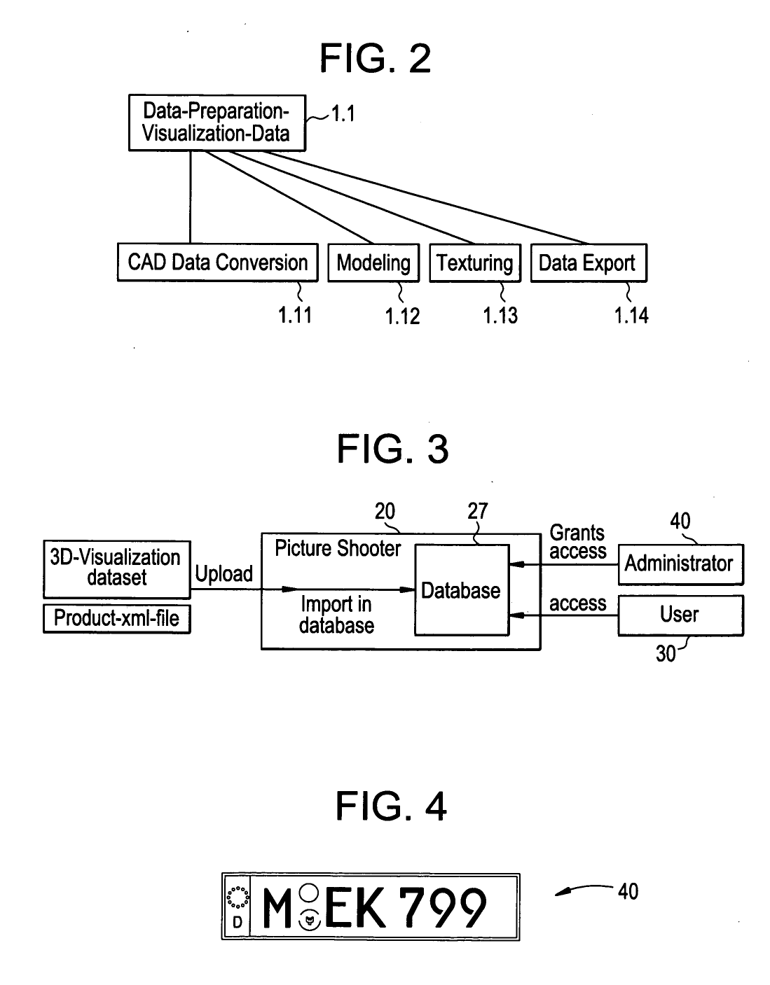

FIG. 2 illustrates a method of data preparation for the 3D visualization data.

At step 1.11, the CAD data (e.g., CAD geometry) is imported into a visualization software (for example, the software 3D Studio Max).

Depending on the data source, the import process involves removing unwanted geometry, tessellation of parametric surfaces to polygon data and converting the file format at step 1.12. In the visualization software, shaders and texture coordinates are assigned to each geometry part at step 1.13. CAD geometry parts that do not fulfill a quality are replaced with newly constructed parts.

The picture shooter process includes a data export into a data format, at step 1.14, that can be read by the picture shooter render engine.

Once steps 1.11-1.14 have been completed, the output at step 1 is a dataset that can be rendered with the picture shooter render engine. The dataset consists of 3D geometry, textures and shading information.

### Step 1.2: Configuration Logic

The configuration logic at step 1.2 uses information about possible product configurations. The information about possible product configurations includes four sets of rules:
1. Rules that apply to the options a client can choose. For example which colors can be chosen or which rims can be chosen with certain trim levels.
2. Rules that apply to certain model parts. For example, if a certain trim level is chosen together with a certain engine, which parts change.
3. Rules to define color and material switches. For example, different car paints of a car chassis depending on the color that a client chooses.
4. Rules to define transformation of objects, for example, if a door of a car is open/closed and the steering of the wheels.

The configuration logic, at step 1.2, is setup so that the rules reference the objects in the 3D scene. The rules are entered into a system that stores them in an .xml file.

The rules are stored in an .xml file that is uploaded to the picture shooter server application 20. This file is referred to as product-xml-file. The product-xml-file includes:
1. Information for dynamically generating the frontend user interfaces. This includes file paths to the icons and texts options. For example, the colors that the user can choose from a product.
2. Configuration logic (e.g., which parts of the model are visible at which chosen option).

### Step 1.3: Data Preparation of Backgrounds

The system supports different kinds of possible. environments (backgrounds) for a product.

Possible environments use a SIBL set for lighting with a flat background image, a SIBL set for lighting with a panoramic background image, or a full CG environment with real 3D objects and individual light setup with different light sources.

The SIBL based environments can be created by uploading a SIBL compatible .zip file. Full CG environments can be uploaded as separate 3D scenes.

SIBL Backgrounds with Flat Background Image (Backplate)

To create the illusion of a virtual product in a real environment the following are used: back plate photography with camera information, if available, a reflection dome and a light dome.

The reflection dome is 360° environment image information around the object.

The light dome is used to define the light setup on location an image map is needed that defines the light sources on the chosen location. This can be derived from the reflection dome by reducing the size and detail information.

To upload all the gathered information in the picture shooter server application 20, an open standard is used, SIBL (http://www.hdrlabs.com/book/index.html).

To create an SIBL Set, 5 (five) files are used:
1) a back plate JPG;
2) a thumbnail for preview (from back plate/50 px);
3) a reflection dome as a 32 bit HDRI (>4K px);
4) lightmap dome as 32 bit HDRI (500 px); and
5) a definition .ibl file that specifies additional parameters of the set.

The five files are compressed into a .zip file.

Based on the five files, a SIBL set is output that is compatible with SIBL standard 1.0.

SIBL Backgrounds with Panoramic Background Image

To create the illusion of a virtual product in a real environment the following are used: 360° Panorama image photography with camera information, if available, a reflection dome and a light dome.

The reflection dome is 360° environment image information around the object and a Light Dome is used to define the light setup on location an image map is needed that defines the light sources on the chosen location. This can be derived from the reflection dome by reducing the size and detail information.

To upload all the gathered information in picture shooter server application 20, an open standard is used SIBL (http://www.hdrlabs.com/book/index.html)

To create an SIBL Set 5 files are used:
1) 360° Panorama image as JPG;
2) thumbnail for preview (from back plate/50 pixels (px));
3) reflection dome as 32 bit HDRI (>4K px);
4) lightmap dome as 32 bit HDRI (500 px); and
5) a definition ibl file that specifies additional parameters of the set.

These five files are compressed into a .zip file. Based on the five files, a SIBL set is output that is compatible with SIBL standard 1.0.

### Step 2: Import of Product Data in Picture Shooter Server Application

In FIG. 3 the importation of product data in the picture shooter server application 20, according to an example embodiment, is shown.

The picture shooter server application 20 is configured to receive the 3D-visualization dataset (Model with high and low resolution) and the product-xml-file.

The 3D-visualization dataset is uploaded to the picture shooter application server. The product is registered in the database by uploading the product-xml-file into the system in the browser on the administration pages. With the information of the product-xml-file the database entries are set up.

The product-xml-file includes information for dynamically generating the frontend user interfaces and configuration logic. The information for dynamically generating the frontend user interfaces includes file paths to the icons and text for visible options such as the colors that the user can choose. The configuration logic indicates which parts of the model are visible at which chosen option. An administrator 40 can grant access to the product to the user 30 of the application. The user 30 can access the dataset in the database 27.

### Step 3: Setup of Product Configuration

The user/client 30 may access a dataset in the picture shooter server application 30 with configuration logic. Based on the dataset, step 3 is executed by the user /client 30.

The frontend 25 automatically creates a user interface (UI) showing the product options that were defined in the product .xml file.

The user/client 30 can then choose from the product options. The picture shooter server application 20 uses the product configuration rules to validate the configuration and ensures that only valid product configurations can be used. The picture shooter server application 30 uses the configuration rules to assemble objects to a valid product.

The validated set of objects that make up the complete product that matches the chosen configuration is output to the user/client 30.

### Step 4: Setup of Perspective and Lighting

The system supports different kinds of possible environments for a product such as an environment that uses a SIBL set for lighting with a flat background image, an

environment that uses a SIBL set for lighting with a panoramic background image and a full CG environment with real 3D objects and individual light setup with different light sources.

The SIBL based environments can be created by uploading a SIBL compatible .zip file at step 1.3. Full computer generated (CG) environments can be uploaded as separate 3D scenes.

The user/client 30 can setup the desired perspective and lighting in the picture shooter server application 30. The picture shooter server application 30 offers a real-time interactive view of the 3D model that resembles the final lighting. The user/client 30 can change the perspective interactively until the user/client 30 is satisfied with the result. Possible ways to change the lighting include choosing from environments and uploading a client's SIBL set to use for lighting.

SIBL based light setups can be tweaked by changing the parameters of the light setup.

Defined perspective and lighting situation for the product. The parameters of the perspective and lighting situation for the product are stored in the database 27 and can be used to order an image in different resolutions.

### Step 5: Upload of Own Backgrounds

The user/client 30 can upload backgrounds. Two possible methods to upload backgrounds include uploading a full SIBL set (as described with reference to step 1) and uploading only a backplate image and choosing the lighting from a SIBL set from the user/client's 30 account.

The SIBL lightset is output from the picture shooter database 27.

### Step 6: Ordering of Images

Defined product configuration and defined light setup from steps 4 and 5 are input to the picture shooter server application 20.

The user/client 30 can order the image in different resolutions and image formats. Examples for image resolutions are 1024×768 pixels, 1920×1280 pixels and 8000×6000 pixels.

Examples for image formats are .tif with 16-bit colordepth, .jpg with 8-bit colordepth and .exr with 16-bit colordepth.

The user/client 30 can choose between full image (product and background in one image) or separate layers for product, shadow and background.

The user/client 30 can order additional layers that help in the retouching process. Examples of additional layers include reflection passes or mask passes.

A renderjob in the renderqueue that was created from the order that the user submitted is generated. A confirmation email that the order was submitted successfully is sent to the user/client 30.

### Step 7: Automated 3D Rendering and Notification of the Client

The picture shooter renderfarm 29 is configured to receive the renderjob in the renderqueue that was created from the order that the user submitted.

The picture shooter server setup consists of the application server 20 and several servers that are used for rendering. These render servers can either be used for the real-time preview or for rendering the ordered images. Depending on the job type the servers use the appropriate render engine.

A client order can consist of multiple order items. This can be different layers of one image (shadow, product, background) or different images of an animated image sequence.

The orders are added to a job queue and are dynamically assigned to free render servers. The servers render the images.

Final renderings are stored to the server's storage. A confirmation email that the images are ready for download is sent from the picture shooter server application 20 to the user/client 30.

### Step 8: Supply of the Rendered Images

The picture shooter frontend 25 is configured to receive the rendered images.

The rendered images are stored on a server (e.g., picture shooter frontend 25) in a download area for the user. This download area is protected so that only the user can access it.

### Step 9: Download of the 3D-Renderings

Final renderings that are stored to the server's storage are available for download by the user/client 30. The user/client 30 can login to the picture shooter server application 20 in a web browser and download the rendered images.

### Step 10: Retouching and Creation of the Images

The user/client 30 downloads the rendered images. - The final retouching steps are done by the user/client 30 or can be assigned to retouching services. The retouching is not part of the automation process.

FIG. 4 shows an automatically rendered number plate texture 50. The picture shooter server application 20 may include a number plate generator. The number plate generator is part of the product configuration at step 3.

The number plate generator is a tool to create an image texture for a car number plate. As input, the tool gets the name of the number plate, for example “M EK 799”. The result is the image texture 50 that contains the name and is shown in FIG. 4.

This image texture 50 can be used by a 3D-dataset to map on 3D-geometry of the number plate. The number plate generator can be adapted to match the number plate appearance of all countries.

The number plate generator is integrated into the picture shooter server application 20. The user can enter the name of the number plate. Then a custom number plate image texture is generated with the number plate generator. There is also a bump map generated by the number plate generator which is used to create the appearance of the bumps of the different letters. This image texture is referenced by the number plate 3D-geometry in the currently chosen product.

A further improvement of the number plate generator is to create real 3D-geometry additional to the image texture. This makes correct rendering of the bumps possible. The 3D-dataset references the created geometry.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for producing computer generated images (CGI) using a server and a computer both connected via a data line or internet comprising:
importing product data in a picture shooter application;
setting up product configuration;
setting up perspective and lighting;
uploading at least one background;
ordering at least one image; and
automated 3D rendering of a computer generated image.

2. The method according to claim 1, further comprising:
generating of product data, wherein the generating includes preparing of visualization data, configuration-logic and the at least one background.

3. The method according to claim 2, wherein the preparing of the visualization data comprises:
converting CAD data;
modeling the converted data;
texturing the converted data; and
exporting into a dataset that includes 3D geometry, textures and shading information based on the modeling and texturing.

4. The method of claim 2, wherein a configuration logic is setup, the configuration logic includes references of at least one object in the at least one background.

5. The method according to claim 4, wherein the configuration logic comprises:
rules of options a client can choose;
rules of model parts;
rules defining color and material switches; and
rules defining a transformation of objects.

6. The method of claim 4, wherein the configuration logic is stored in a product .xml file and includes information for dynamically generating frontend user interfaces and the configuration logic.

7. The method of claim 2, wherein the preparing of the at least one background comprises:
creating a smart image based lighting (SIBL) set including,
a background image file,
a thumbnail preview of the background image file,
a reflection dome, the reflection dome being a 32 bit high dynamic range image (HDRI),
a lightmap dome, the lightmap dome being a 32 bit HDRI, and
a definition .ibl file.

8. The method of claim 7, wherein the background image file is one of
a flat background image,
a 360° panoramic background image, and
a computer generated image.

9. The method of claim 7, wherein the background image file, the thumbnail, the reflection dome, the lightmap dome and the definition .ibl file are compressed into a .zip file.

10. The method of claim 6, wherein the setup of the product configuration includes a front end, the front end automatically creates a user interface showing product options in the product .xml file.

11. The method of claim 1, wherein the computer is configured to setup the perspective and lighting in the picture shooter application.

12. The method of claim 1, wherein the computer is configured to change the lighting by selecting from environments or by uploading a SIBL set from the user.

13. The method of claim 1, wherein the uploading comprises:
uploading a SIBL set or a backplate image and selecting the lighting from the SIBL set.

14. The method of claim 1, wherein the computer is configured to select between a full image or separate layers for the product, shadow and background.

15. The method of claim 1, wherein a client order is added to a job queue and is dynamically assigned to free render servers.

16. The method of claim 1, wherein the images are stored on a server.

17. The method of claim 1, wherein the images are downloaded to the computer.

18. The method of claim 17, wherein the images are downloaded from the picture shooter application.

19. The method of claim 1, further comprising:
retouching the images and creating final images based on the retouching.

20. The method of claim 3, wherein a configuration logic is setup, the configuration logic includes references of at least one object in the at least one background.
